(19) United States
(12) Patent Application Publication
(10) Pub. No.: US 2016/0080249 A1
(43) Pub. Date: Mar. 17, 2016

(54) PREVENT VRRP MASTER / MASTER SPLIT IN ACTIVE / STANDBY ICR SYSTEM

(71) Applicant: Telefonaktiebolaget L M Ericsson (publ), Stockholm (SE)

(72) Inventor: Juan Lu, Sunnyvale, CA (US)

(21) Appl. No.: 14/488,584

(22) Filed: Sep. 17, 2014

(51) Int. Cl. H04L 12/703; H04L 1/22; H04L 12/707; H04L 12/713

(52) U.S. Cl. CPC H04L 45/28; H04L 45/586; H04L 1/22; H04L 45/22

(57) ABSTRACT

Exemplary methods for preventing a master/master split condition in a virtual router redundancy protocol (VRRP) router comprising of a first network device configured to serve as a backup router of the VRRP router, and a second network device configured to serve as a master router of the VRRP router, include in response to determining that there is a possibility that the second network device is no longer capable of forwarding network traffic as the master router of the VRRP router, transitioning into a curfew state. The methods further include in response to determining that a VRRP advertisement message was not received within a master_down_interval, determining to not transition to serving as the master router of the VRRP router in response to determining the first network device is in the curfew state.

### FIELD

Embodiments of the invention relate to the field of packet networks; and more specifically, to the prevention of Virtual Router Redundancy Protocol (VRRP) master/master split in an active/standby Inter Chassis Redundancy system.

### BACKGROUND

A typical Access/Aggregation network has 1000's of subscriber circuits (e.g., virtual local access networks (VLANs)) on which subscribers are connected to an edge router, such as a broadband network gateway (BNG) router. In some instances, the edge router is a Virtual Router Redundancy Protocol (VRRP) router, i.e., a collection of physical routers that support the VRRP protocol. A VRRP router/instance includes one physical router operating as the master router of the VRRP router and one or more other physical routers operating as backup routers of the VRRP router. In a VRRP router, only the master router is enabled to accept subscriber traffic and forward it to an external network such as the Internet. Subscriber traffic directed at any of the backup routers are discarded.

A master router is selected among the physical routers in the VRRP instance based on priorities assigned to the physical routers. When a physical router switches state from being a backup router to a master router, the master router is required to send gratuitous Address Resolution Protocol (ARP) messages to notify the subscriber circuits of its virtual Media Access Control (MAC) address and virtual Internet Protocol (IP) address of the VRRP router. The gratuitous ARP messages cause the subscriber circuits to update their bridging tables. The updated bridging tables cause subscriber traffic to be properly routed to the master router instead of a backup router. A master router is also required to periodically send VRRP Advertisement (Ad) messages to all backup routers of the VRRP router notifying the backup routers of the master router running status.

When the master router or any one of its links fail, the master router switches to being a backup router. A new master router is then selected based on priorities as discussed above. The new master router sends gratuitous ARP messages to the subscriber circuits, causing traffic to be directed to the new master router, instead of the “original” master router.

The conventional VRRP router role switching described above, however, is problematic in cases where there is a network failure that is not detectable by the master router. FIG. 1 illustrates network 100 comprising of user equipment (UE) 104 communicatively coupled to switch 103 (e.g., an Ethernet switch). Switch 103 is communicatively coupled to VRRP router 110, which in turn, is communicatively coupled to network devices 106 and 107. In this example, VRRP router 110 comprises network device 102 configured to serve as the master router. Network device 102 has established active link aggregation group (LAG) 130 with network device 107 (e.g., using by using the Link Aggregation Control Protocol (LACP)). Thus, traffic received by network device 102 on the access side can be forwarded to network device 107 on the trunk side because LAG 130 is in the active state.

VRRP router 110 also comprises network device 101 configured to serve as the backup router. Network device 101 has established link aggregation group (LAG) 131 with network device 106. LAG 131, however, is not in the active state. Thus, traffic received by network device 101 on the access side cannot be forwarded to network device 108 on the trunk side because LAG 131 is in the standby state.

Under normal operating condition, network device 102 (i.e., the master router) periodically sends VRRP Ads which are received by network device 101 (i.e., the backup router). When switch 103 (e.g., multicast forwarder 105) fails to forward the multicast VRRP Ads, the Ads never reach network device 101. In response to not receiving these VRRP Ads, network device 101 switches out of backup state and enters master state, and the result is a VRRP master/master split. Network device 101 starts sending out gratuitous ARPs, causing some of the traffic from UE 104 to be directed at network device 101. For example, traffic 112 from UE 104 is directed toward network device 102, which successfully forwards it toward network device 107 because LAG 130 is active. Traffic 113 from UE 104 is directed toward network device 101, which is discarded/dropped because LAG 131 is not active. Accordingly, there is a need for a mechanism to prevent a VRRP master/master split condition.

### SUMMARY

Exemplary methods performed by a first network device of a virtual router redundancy protocol (VRRP) router, the VRRP router comprising of the first network device configured to serve as a backup router of the VRRP router, and a second network device configured to serve as a master router of the VRRP router, include in response to determining that there is a possibility that the second network device is no longer capable of forwarding network traffic as the master router of the VRRP router, transitioning into a curfew state. The methods further include in response to determining that a VRRP advertisement message was not received within a master_down_interval, determining to not transition to serving as the master router of the VRRP router in response to determining the first network device is in the curfew state.

According to one embodiment, determining that there is the possibility that the second network device is no longer capable of forwarding network traffic as the master router of the VRRP router comprises determining that a VRRP advertisement was not received within a master_down_alert_interval, wherein the master_down_alert_interval is a shorter time interval than the master_down_interval.

In one embodiment, the exemplary methods further include receiving, from the second network device, its VRRP state information, and storing, in a database, the VRRP state information received from the second network device. According to one embodiment, the exemplary methods include prior to transitioning into the curfew state, determining the second network device is the master router of the VRRP router based on the VRRP state information stored in the database.

According to one embodiment, the methods include in response to receiving, while in the curfew state, a VRRP advertisement from the second network device, exiting the curfew state. In one embodiment, the methods include in response to receiving, while in the curfew state, VRRP state information from the second network device indicating the second network device is no longer serving as the master router of the VRRP router, exiting the curfew state.

According to one embodiment, the methods include after exiting the curfew state, transitioning to serving as the master router of the VRRP router, and sending VRRP state information of the first network device to the second network device.

### BRIEF DESCRIPTION OF THE DRAWINGS

The invention may best be understood by referring to the following description and accompanying drawings that are used to illustrate embodiments of the invention. In the drawings:

FIG. 1 is a block diagram illustrating a master/master split condition in a conventional VRRP router.

FIG. 2 is a block diagram illustrating a VRRP router according to one embodiment.

FIG. 3 is a transaction diagram illustrating transactions for preventing a master/master split condition in a VRRP router according to one embodiment.

FIG. 4 is a transaction diagram illustrating transactions for preventing a master/master split condition in a VRRP router according to one embodiment.

FIG. 5 is a transaction diagram illustrating transactions for preventing a master/master split condition in a VRRP router according to one embodiment.

FIG. 6 is a flow diagram illustrating a method for preventing a master/master split condition in a VRRP router according to one embodiment.

FIG. 7A illustrates connectivity between network devices (NDs) within an exemplary network, as well as three exemplary implementations of the NDs, according to some embodiments of the invention.

FIG. 7B illustrates an exemplary way to implement the special-purpose network device 702 according to some embodiments of the invention.

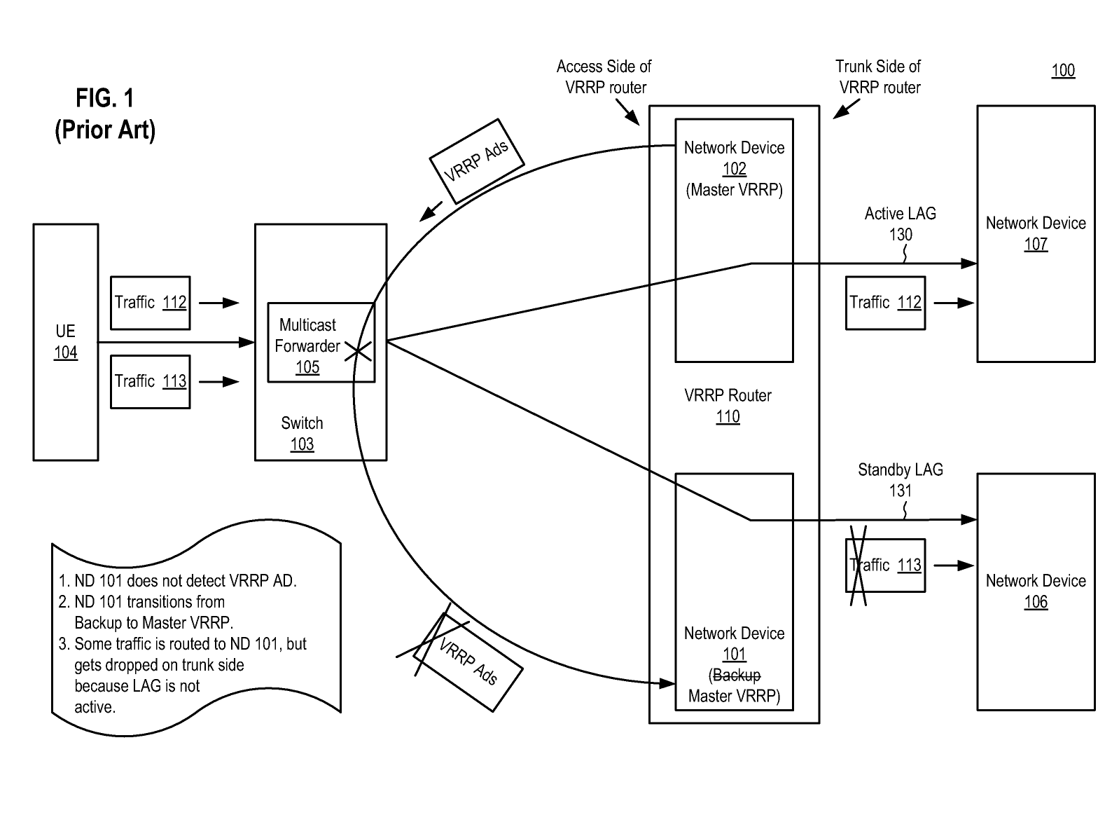

### DESCRIPTION OF EMBODIMENTS

The following description describes methods and apparatuses for preventing a VRRP master/master split condition. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

Techniques for preventing a VRRP master/master split condition are described herein. According to one embodiment, a VRRP router includes a first network device and a second network device. The first network device is configured to serve as a backup VRRP router (herein referred to simply as a backup router). The second network device is configured to serve as a master VRRP router (herein referred to simply as a master router). The master router is configured to periodically send VRRP Ads to the backup router, indicating that the master router is operating normally. The backup router, as long as it continues to receive such VRRP Ads periodically, will remain as the backup router.

In some instances, the VRRP Ads sent by the master router do not reach the backup router. For example, a switch responsible for forwarding these multicast VRRP Ads may not be functioning properly (e.g., its multicast forwarder has failed). According to one embodiment, in response to not receiving a VRRP Ad before the expiration of a master_down_alert_timer, the backup router determines that there is a possibility that the master router is no longer capable of forwarding network traffic as the master router of the VRRP router. In one embodiment, the master_down_alert_timer is preloaded with a master_down_alert interval.

In response to determining that there is a possibility of a failed master router, the backup router determines whether a local VRRP database indicates the master router is in the master state. In one embodiment, the local VRRP database includes VRRP state information received from the peer router(s). For example, whenever the master router switches from master to init/backup state, or vice versa, it is configured to send its VRRP state information to the backup router. Such VRRP state information is stored by the backup router in its local VRRP database.

In response to determining that there is a possibility of a failed master router, and the local VRRP database indicating the master router is in a non-master state (e.g., an init state), the backup router waits for a master_down_timer to expire. The master_down_timer is preloaded with a master_down_interval (as defined by Request for Comments (RFC) 5798, which is hereby incorporated by reference). In one embodiment, the master_down_interval is greater than the master_down_alert_interval. In response to detecting the expiration of the master_down_timer (without receiving a VRRP Ad), the backup router enters the VRRP master state. Throughout the description, references are made to the backup router entering the master state. It shall be understood that the backup router has participated in the VRRP master election process as defined by RFC 5798, and was elected as the new master router (e.g., due to its VRRP priority). For the sake of brevity, the description will not discuss the details the master election process.

It should be noted here that in a conventional VRRP router, VRRP state information are not distributed among the master and backup routers. Without such VRRP state information, the backup routers simply assume that the master router is down whenever the VRRP Ad is not received at the master_down_interval. This can result in a VRRP master/master split as described above. Embodiments of the present invention overcome these limitations by providing mechanisms for each router of the VRRP router to share its respective VRRP state, thus, allowing each backup router to more intelligently determine whether the absence of a VRRP Ad is due to a failed master router (or a failed VRRP interface/port) as opposed to a non-VRRP related failure (e.g., a failed multicast forwarder within a switch). The ability to determine that the absence of an expected VRRP Ad is due to a failure such as a multicast forwarder failure allows the backup router to remain a backup router, and prevents a master/master split condition.

In response to determining that there is a possibility of a failed master router, and the local VRRP database indicating the master router is still in the master state, the backup router transitions into a curfew state. As used herein, the “curfew state” refers to a state in which the backup router does not transition to the master state regardless of how many expected VRRP Ads are missing (i.e., not received) and regardless of its VRRP priority (described in RFC 5798). In one embodiment, while in the curfew state, the backup router does not participate in the VRRP master election process regardless of how many master_down_intervals have elapsed without the backup router receiving a VRRP Ad. By way of example, assume that the backup router's VRRP priority is such that it would have become a master router if the master router failed, but because the backup router is in the curfew state, it is prevented from entering the master state because the master router is not truly down.

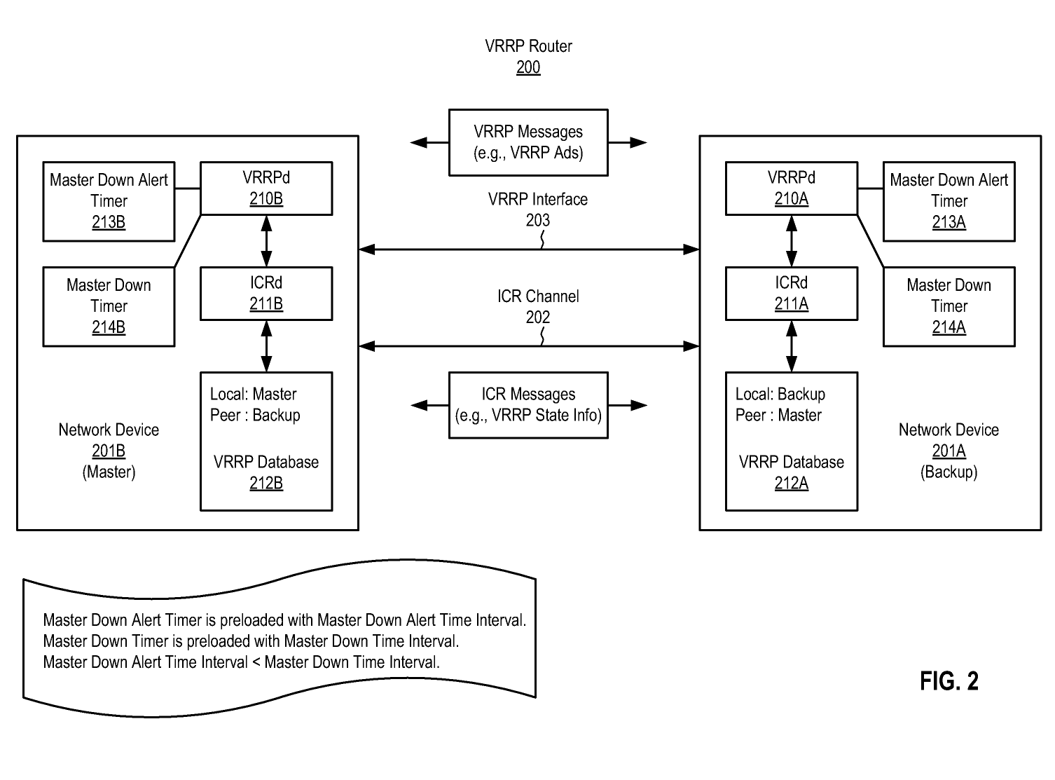

FIG. 2 is a block diagram illustrating VRRP router 200 according to one embodiment. For example, VRRP router 200 may be implemented in a network similar to network 100. Details of the network, however, have been omitted in order to avoid obscuring the invention.

Referring now to FIG. 2. VRRP router 200 includes network device 201A configured to serve as a backup router, and network device 201B configured to serve as a master router. Network devices 201A and 201B exchange ICR messages via ICR channel 202. For example, ICR messages include, but not limited to, messages that include VRRP state information of each respective router. The VRRP state information are stored in VRRP databases 212A and 212B, which are stored in storage devices accessible by network devices 201A and 201B, respectively. Network devices 201A and 201B exchange VRRP related messages (e.g., VRRP Ads) via VRRP interface 203.

Network device 201A includes VRRP daemon (VRRPd) 210A, which can be implemented in software, firmware, hardware, or any combination thereof. VRRPd 210A is configured to maintain the VRRP state of network device 201A, for example, by transitioning between VRRP init, backup, and master states (described in RFC 5798). VRRPd 210A is to maintain master_down_alert_timer 213A and master_down_timer 214A, which are preloaded with master_down_alert_interval and master_down_interval, respectively. Master_down_interval is described in RFC 5798, and master_down_alert_interval is set to a value which is less than master_down_interval.

In response to not receiving a VRRP Ad from network device 201B before master_down_alert_timer 213A expires, VRRPd 210A sends an alert to ICR daemon (ICRd) 211A. ICRd 211A can be implemented in software, firmware, hardware, or any combination thereof. In response to the alert, ICRd 211A determines whether VRRP database 212A indicates network device 201B is in the master state. In response to VRRP database 212A indicating network device 201B is not a master router, ICRd 211A does not impose a curfew on VRRPd 210A, for example, by not instructing VRRPd 210A to enter the curfew state. In response to not receiving a VRRP Ad from network device 201B before master_down_timer 214A expires, VRRPd 210A transitions to the master state, if VRRPd 210A determines that it is currently not in the curfew state.

Alternatively, in response to VRRP database 212A indicating network device 201B is in the master state, ICRd 211A imposes a curfew on VRRPd 210A, for example, by instructing VRRPd 210A to enter the curfew state. In response to not receiving a VRRP Ad from network device 201B before master_down_timer 214A expires, VRRPd 210A does not transition to the master state, if VRRPd 210A determines that it is currently in the curfew state. For example, VRRPd 210A does not attempt to become a master router by participating in a master election process. In one embodiment, VRRPd 210A exits the curfew state in response to network device 201A receiving a VRRP Ad from network device 201B (e.g., a failure in a multicast forwarder has been resolved). In one embodiment, VRRPd 210A exits the curfew state in response to network device 201A receiving an ICR message from network device 201B indicating it is no longer serving as the master router (e.g., because VRRP interface 203 is down).

Network device 201B comprises VRRPd 210B, ICRd 211B, VRRP database 212B, master_down_alert_timer 213B, and master_down_timer 214B, which are configured to perform operations similar to VRRPd 210A, ICRd 211A, VRRP database 212A, master_down_alert_timer 213A, and master_down_timer 214A, respectively.

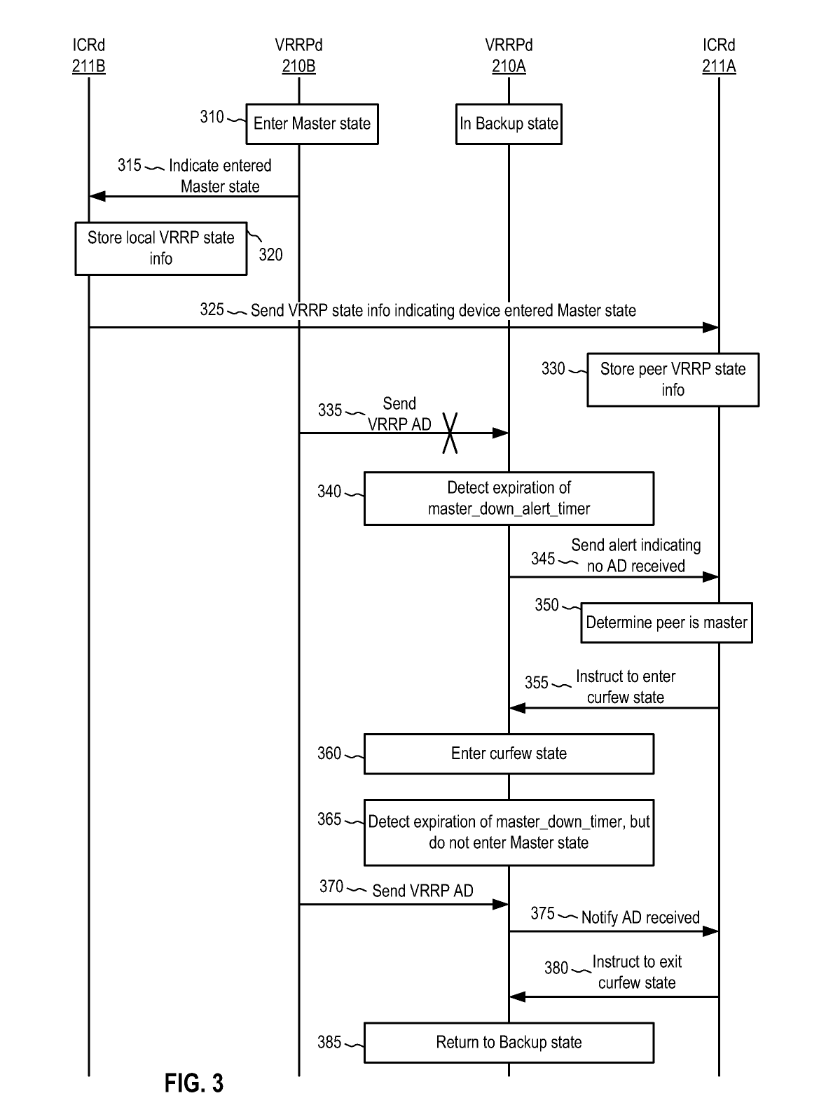

FIG. 3 is a transaction diagram illustrating transactions for preventing VRRP master/master split according to one embodiment. FIG. 3 assumes that VRRPd 210A is currently in the backup state. At transaction 310, VRRPd 210B enters the master state. Conventionally, a VRRP daemon does not communicate its VRRP state information to its ICR daemon. As a result, an ICR daemon of one network device is not able to communicate its VRRP state to other VRRP enabled network devices. As a result, a conventional VRRP daemon is not able to intelligently determine if it should enter the master state when a VRRP Ad is not received. Embodiments of the present invention overcome these limitations by providing mechanisms for the VRRP state information to be distributed among the routers.

At transaction 315, VRRPd 210B indicates to ICRd 211B that it has entered master state. At transaction 320, ICRd 211B stores the local VRRP state info (e.g., as part of VRRP database 212B). At transaction 325, ICRd 211B sends its VRRP state information (e.g., via ICR channel 202) to ICRd 211A indicating network device 210B has entered the master state. At transaction 330, ICRd 211A stores the received VRRP state information (e.g., as part of VRRP database 212A).

At transaction 335, VRRPd 210B sends a VRRP Ad, but it does not reach VRRPd 210A (e.g., because of a multicast forwarder failure at a switch). Conventionally, when a backup router detects an expiration of a master_down_timer, it automatically assumes the master router is down, and attempts to become a master router by participating in the master selection process. As described above, this may result in a master/master split condition if the VRRP Ad is not received due to a multicast forwarding failure. Embodiments of the present invention overcome these limitations by determining whether the master router is still in the master state, and if so, prevents the backup router from becoming a master router, even though VRRP Ads are not received.

At transaction 340, VRRPd 210A detects an expiration of master_down_alert_timer 213A. Throughout the description, references are made to expirations of master_down_alert_timers and master_down_timers. It shall be understood that an expiration of a timer implies a VRRP Ad was not received before the respective timer expired. At transaction 345, VRRPd 210A sends an alert to ICRd 211A indicating no VRRP Ad was received before master_down_alert_timer 213A expired. At transaction 350, ICRd 211A determines that network device 210B is in the master state (e.g., based on VRRP state information stored in VRRP database 212A). At transaction 355, ICRd 211A imposes a curfew on VRRPd 210A by instructing it to enter the curfew state. At transaction 360, VRRPd 210A enters the curfew state. At transaction 365, VRRPd 210A detects an expiration of master_down_timer 214A, but does not enter the master state because it is currently in the curfew state (i.e., a curfew is currently being imposed). Accordingly, a master/master split condition is prevented.

At transaction 370, VRRPd 210B sends a VRRP Ad which is received by VRRPd 210A (e.g., because the multicast forwarding failure has been resolved). At transaction 375, VRRPd 210A sends a notification to ICRd 211A indicating a VRRP Ad has been received. At transaction 380, ICRd 211A lifts the curfew by instructing VRRPd 210A to exit the curfew state. At transaction 385, VRRPd 210A returns to the backup state.

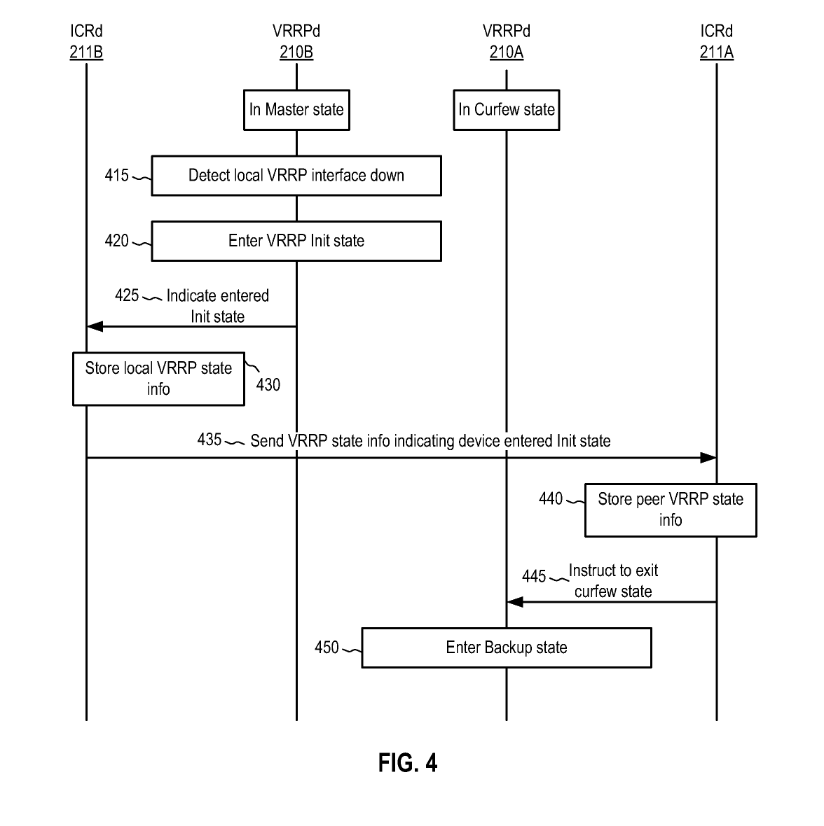

FIG. 4 is a transaction diagram illustrating transactions for preventing VRRP master/master split according to one embodiment. FIG. 4 assumes that VRRPd 210A and VRRPd 210B are currently in the curfew state and master state, respectively. At transaction 415, VRRPd 210B detects a local VRRP interface (e.g., VRRP interface 203) is down. At transaction 420, VRRPd 210B enters the VRRP init state. At transaction 425, VRRPd 210B sends a notification to ICRd 211B indicating it has entered the init state. At transaction 430, ICRd 211B stores the local VRRP state information (e.g., as part of VRRP database 212B). At transaction 435, ICRd 211B sends its VRRP state information (e.g., via ICR channel 202) to ICRd 211A indicating network device 210B has entered the init state. At transaction 440, ICRd 211A stores the received VRRP state information (e.g., as part of VRRP database 212A). At transaction 445, ICRd 211A lifts the curfew by instructing VRRPd 210A to exit the curfew state. At transaction 450, VRRPd 210A returns to the backup state.

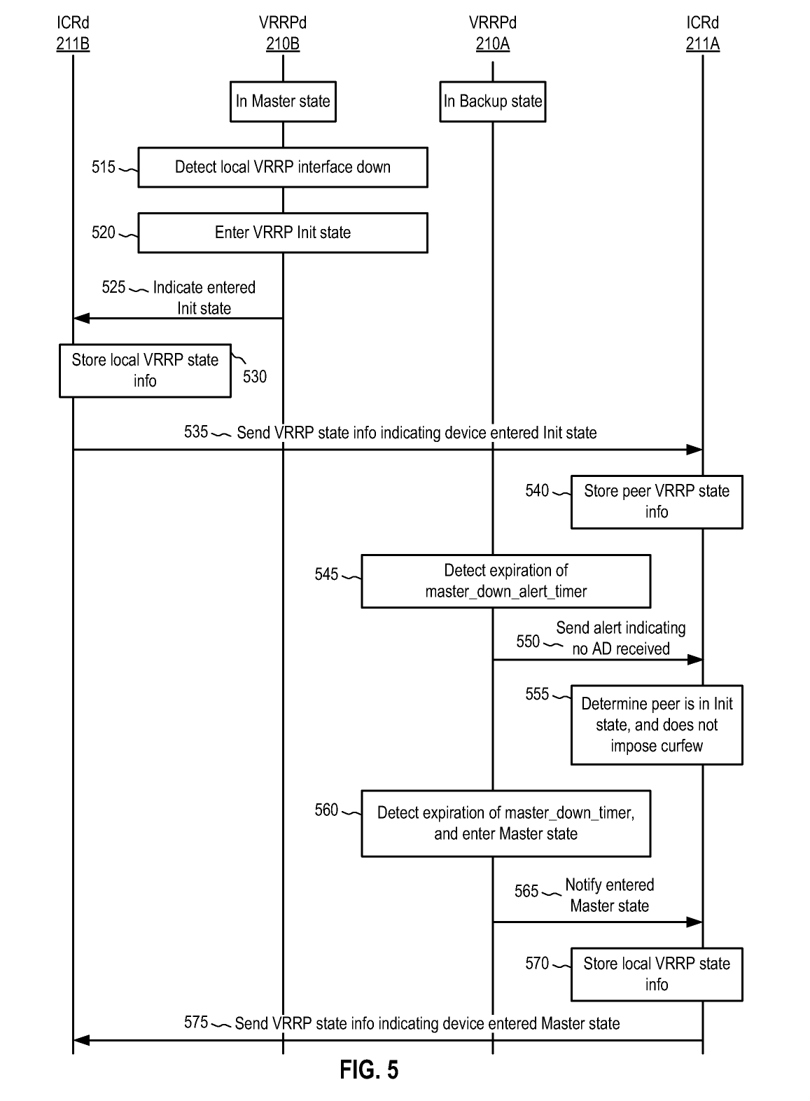

FIG. 5 is a transaction diagram illustrating transactions for preventing VRRP master/master split according to one embodiment. FIG. 5 assumes that VRRPd 210A and VRRPd 210B are currently in the backup state and master state, respectively. At transaction 515, VRRPd 210B detects a local VRRP interface (e.g., VRRP interface 203) is down. At transaction 520, VRRPd 210B enters the VRRP init state. At transaction 525, VRRPd 210B sends a notification to ICRd 211B indicating it has entered the init state. At transaction 530, ICRd 211B stores the local VRRP state information (e.g., as part of VRRP database 212B). At transaction 535, ICRd 211B sends its VRRP state information (e.g., via ICR channel 202) to ICRd 211A indicating network device 210B has entered the init state. At transaction 540, ICRd 211A stores the received VRRP state information (e.g., as part of VRRP database 212A). At transaction 545, VRRPd 210A detects an expiration of master_down_alert_timer 213A.

At transaction 550, VRRPd 210A sends an alert to ICRd 211A indicating no VRRP Ad was received before master_down_alert_timer 213A expired. At transaction 555, ICRd 211A determines that network device 210B is in the init state (e.g., based on VRRP state information stored in VRRP database 212A), and does not impose a curfew on VRRPd 210A.

At transaction 560, VRRPd 210A detects an expiration of master_down_timer 214A, and enters the master state because it is currently not in the curfew state (i.e., a curfew is not currently being imposed). At transaction 565, VRRPd 210A notifies ICRd 211A that it has entered the master state. At transaction 570, ICRd 211A stores the local VRRP state info (e.g., as part of VRRP database 212A). At transaction 575, ICRd 211A sends its VRRP state information (e.g., via ICR channel 202) to ICRd 211B indicating network device 210A has entered the master state.

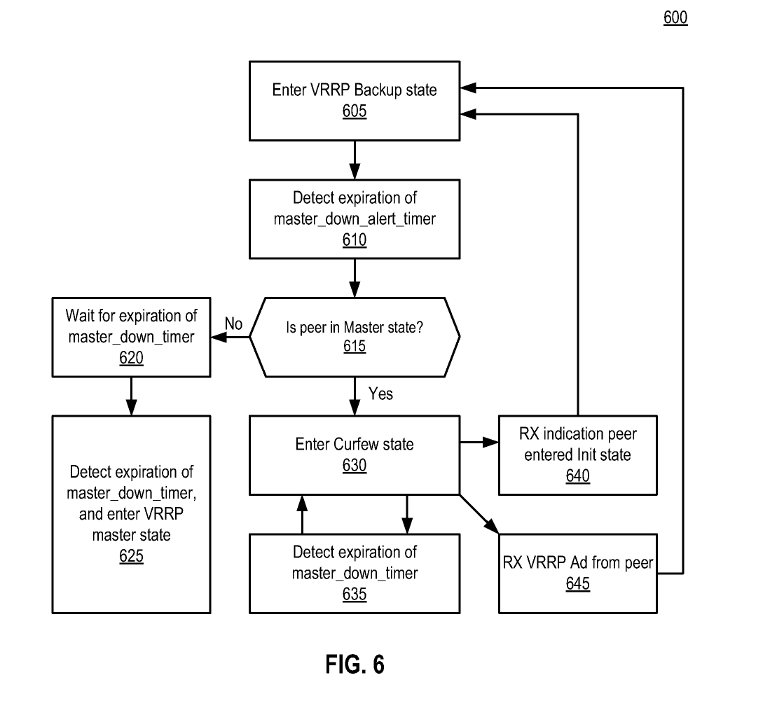

FIG. 6 is a flow diagram illustrating method 600 for preventing VRRP master/master split condition according to one embodiment. For example, method 600 can be performed by network device 201A (e.g., VRRPd 210A and ICRd 211A of network device 201A). Method 600 can be implemented in software, firmware, hardware, or any combination thereof. The operations in this and other flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

Referring now to FIG. 6. At block 605, network device 201A enters VRRP backup state. At block 610, network device 201A detects an expiration of master_down_alert_timer 213A (e.g., as part of transaction 340 or 545). At block 615, network device 201A determines whether the peer router is in the VRRP master state (e.g., as part of transaction 350 or 555). At block 620, in response to determining the peer router is not in the VRRP master state (e.g., based on VRRP state information stored in a local VRRP database), network device 201A waits for an expiration of master_down_timer 214A. At block 625, network device 201A detects an expiration of master_down_timer 214A and enters VRRP master state (e.g., as part of transaction 560).

Returning now back to block 615. In response to determining the peer router is in the master state, network device 201A transitions to block 630 and enters the curfew state (e.g., as part of transactions 350, 355, and 360). At block 635, network device 201A detects an expiration of master_down_timer 214A, but remains in the curfew state instead of entering the master state (e.g., as part of transaction 365).

At block 640, network device 201A receives an indication that the peer router entered the Init state and exits the curfew state by returning to the backup state (e.g., as part of transactions 440, 445, and 450). At block 645, network device 201A receives a VRRP Ad from the peer router and exits the curfew state by returning to the backup state (e.g., as part of transactions 375, 380, and 385).

An electronic device or a computing device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set or one or more physical network interface(s) to establish network connections (to transmit and/or receive code and/or data using propagating signals) with other electronic devices. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

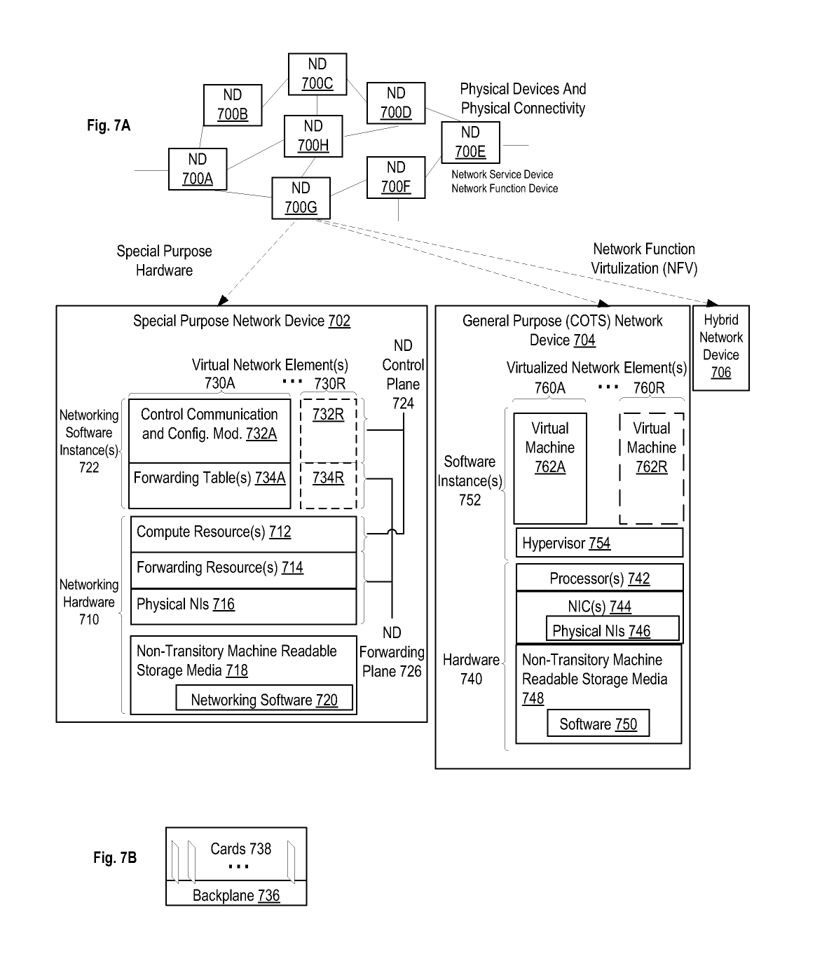

FIG. 7A illustrates connectivity between network devices (NDs) within an exemplary network, as well as three exemplary implementations of the NDs, according to some embodiments of the invention. FIG. 7A shows NDs 700A-H, and their connectivity by way of lines between A-B, B-C, C-D, D-E, E-F, F-G, and A-G, as well as between H and each of A, C, D, and G. These NDs are physical devices, and the connectivity between these NDs can be wireless or wired (often referred to as a link). An additional line extending from NDs 700A, E, and F illustrates that these NDs act as ingress and egress points for the network (and thus, these NDs are sometimes referred to as edge NDs; while the other NDs may be called core NDs).

Two of the exemplary ND implementations in FIG. 7A are: 1) a special-purpose network device 702 that uses custom application-specific integrated-circuits (ASICs) and a proprietary operating system (OS); and 2) a general purpose network device 704 that uses common off-the-shelf (COTS) processors and a standard OS.

The special-purpose network device 702 includes networking hardware 710 comprising compute resource(s) 712 (which typically include a set of one or more processors), forwarding resource(s) 714 (which typically include one or more ASICs and/or network processors), and physical network interfaces (NIs) 716 (sometimes called physical ports), as well as non-transitory machine readable storage media 718 having stored therein networking software 720. A physical NI is hardware in a ND through which a network connection (e.g., wirelessly through a wireless network interface controller (WNIC) or through plugging in a cable to a physical port connected to a network interface controller (NIC)) is made, such as those shown by the connectivity between NDs 700A-H. During operation, the networking software 720 may be executed by the networking hardware 710 to instantiate a set of one or more networking software instance(s) 722. Each of the networking software instance(s) 722, and that part of the networking hardware 710 that executes that network software instance (be it hardware dedicated to that networking software instance and/or time slices of hardware temporally shared by that networking software instance with others of the networking software instance(s) 722), form a separate virtual network element 730A-R. Each of the virtual network element(s) (VNEs) 730A-R includes a control communication and configuration module 732A-R (sometimes referred to as a local control module or control communication module) and forwarding table(s) 734A-R, such that a given virtual network element (e.g., 730A) includes the control communication and configuration module (e.g., 732A), a set of one or more forwarding table(s) (e.g., 734A), and that portion of the networking hardware 710 that executes the virtual network element (e.g., 730A).

Software 720 can include code which be executed by networking hardware 710, cause networking hardware 710 to perform operations of one or more embodiments of the present invention as part networking software instances 722.

The special-purpose network device 702 is often physically and/or logically considered to include: 1) a ND control plane 724 (sometimes referred to as a control plane) comprising the compute resource(s) 712 that execute the control communication and configuration module(s) 732A-R; and 2) a ND forwarding plane 726 (sometimes referred to as a forwarding plane, a data plane, or a media plane) comprising the forwarding resource(s) 714 that utilize the forwarding table(s) 734A-R and the physical NIs 716. By way of example, where the ND is a router (or is implementing routing functionality), the ND control plane 724 (the compute resource(s) 712 executing the control communication and configuration module(s) 732A-R) is typically responsible for participating in controlling how data (e.g., packets) is to be routed (e.g., the next hop for the data and the outgoing physical NI for that data) and storing that routing information in the forwarding table(s) 734A-R, and the ND forwarding plane 726 is responsible for receiving that data on the physical NIs 716 and forwarding that data out the appropriate ones of the physical NIs 716 based on the forwarding table(s) 734A-R.

FIG. 7B illustrates an exemplary way to implement the special-purpose network device 702 according to some embodiments of the invention. FIG. 7B shows a special-purpose network device including cards 738 (typically hot pluggable). While in some embodiments the cards 738 are of two types (one or more that operate as the ND forwarding plane 726 (sometimes called line cards), and one or more that operate to implement the ND control plane 724 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec), Secure Sockets Layer (SSL)/Transport Layer Security (TLS), Intrusion Detection System (IDS), peer-to-peer (P2P), Voice over IP (VoIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 736 (e.g., a first full mesh coupling the line cards and a second full mesh coupling all of the cards).

Returning to FIG. 7A, the general purpose network device 704 includes hardware 740 comprising a set of one or more processor(s) 742 (which are often COTS processors) and network interface controller(s) 744 (NICs; also known as network interface cards) (which include physical NIs 746), as well as non-transitory machine readable storage media 748 having stored therein software 750. During operation, the processor(s) 742 execute the software 750 to instantiate a hypervisor 754 (sometimes referred to as a virtual machine monitor (VMM)) and one or more virtual machines 762A-R that are run by the hypervisor 754, which are collectively referred to as software instance(s) 752. A virtual machine is a software implementation of a physical machine that runs programs as if they were executing on a physical, non-virtualized machine; and applications generally do not know they are running on a virtual machine as opposed to running on a “bare metal” host electronic device, though some systems provide para-virtualization which allows an operating system or application to be aware of the presence of virtualization for optimization purposes. Each of the virtual machines 762A-R, and that part of the hardware 740 that executes that virtual machine (be it hardware dedicated to that virtual machine and/or time slices of hardware temporally shared by that virtual machine with others of the virtual machine(s) 762A-R), forms a separate virtual network element(s) 760A-R.

The virtual network element(s) 760A-R perform similar functionality to the virtual network element(s) 730A-R. For instance, the hypervisor 754 may present a virtual operating platform that appears like networking hardware 710 to virtual machine 762A, and the virtual machine 762A may be used to implement functionality similar to the control communication and configuration module(s) 732A and forwarding table(s) 734A (this virtualization of the hardware 740 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). However, different embodiments of the invention may implement one or more of the virtual machine(s) 762A-R differently. For example, while embodiments of the invention are illustrated with each virtual machine 762A-R corresponding to one VNE 760A-R, alternative embodiments may implement this correspondence at a finer level granularity (e.g., line card virtual machines virtualize line cards, control card virtual machine virtualize control cards, etc.); it should be understood that the techniques described herein with reference to a correspondence of virtual machines to VNEs also apply to embodiments where such a finer level of granularity is used.

In certain embodiments, the hypervisor 754 includes a virtual switch that provides similar forwarding services as a physical Ethernet switch. Specifically, this virtual switch forwards traffic between virtual machines and the NIC(s) 744, as well as optionally between the virtual machines 762A-R; in addition, this virtual switch may enforce network isolation between the VNEs 760A-R that by policy are not permitted to communicate with each other (e.g., by honoring virtual local area networks (VLANs)).

Software 750 can include code which be executed by processors 742, cause the processors to perform operations of one or more embodiments of the present invention as part virtual machine 762A-R.

The third exemplary ND implementation in FIG. 7A is a hybrid network device 706, which includes both custom ASICs/proprietary OS and COTS processors/standard OS in a single ND or a single card within an ND. In certain embodiments of such a hybrid network device, a platform VM (i.e., a VM that that implements the functionality of the special-purpose network device 702) could provide for para-virtualization to the networking hardware present in the hybrid network device 706.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 730A-R, VNEs 760A-R, and those in the hybrid network device 706) receives data on the physical NIs (e.g., 716, 746) and forwards that data out the appropriate ones of the physical NIs (e.g., 716, 746). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP), Transmission Control Protocol (TCP), and differentiated services (DSCP) values.

The NDs of FIG. 7A, for example, may form part of the Internet or a private network; and other electronic devices (not shown; such as end user devices including workstations, laptops, netbooks, tablets, palm tops, mobile phones, smartphones, multimedia phones, Voice Over Internet Protocol (VOIP) phones, terminals, portable media players, GPS units, wearable devices, gaming systems, set-top boxes, Internet enabled household appliances) may be coupled to the network (directly or through other networks such as access networks) to communicate over the network (e.g., the Internet or virtual private networks (VPNs) overlaid on (e.g., tunneled through) the Internet) with each other (directly or through servers) and/or access content and/or services. Such content and/or services are typically provided by one or more servers (not shown) belonging to a service/content provider or one or more end user devices (not shown) participating in a peer-to-peer (P2P) service, and may include, for example, public webpages (e.g., free content, store fronts, search services), private webpages (e.g., username/password accessed webpages providing email services), and/or corporate networks over VPNs. For instance, end user devices may be coupled (e.g., through customer premise equipment coupled to an access network (wired or wirelessly)) to edge NDs, which are coupled (e.g., through one or more core NDs) to other edge NDs, which are coupled to electronic devices acting as servers. However, through compute and storage virtualization, one or more of the electronic devices operating as the NDs in FIG. 7A may also host one or more such servers (e.g., in the case of the general purpose network device 704, one or more of the virtual machines 762A-R may operate as servers; the same would be true for the hybrid network device 706; in the case of the special-purpose network device 702, one or more such servers could also be run on a hypervisor executed by the compute resource(s) 712); in which case the servers are said to be co-located with the VNEs of that ND.

A virtual network is a logical abstraction of a physical network (such as that in FIG. 7A) that provides network services (e.g., L2 and/or L3 services). A virtual network can be implemented as an overlay network (sometimes referred to as a network virtualization overlay) that provides network services (e.g., layer 2 (L2, data link layer) and/or layer 3 (L3, network layer) services) over an underlay network (e.g., an L3 network, such as an Internet Protocol (IP) network that uses tunnels (e.g., generic routing encapsulation (GRE), layer 2 tunneling protocol (L2TP), IPSec) to create the overlay network).

A network virtualization edge (NVE) sits at the edge of the underlay network and participates in implementing the network virtualization; the network-facing side of the NVE uses the underlay network to tunnel frames to and from other NVEs; the outward-facing side of the NVE sends and receives data to and from systems outside the network. A virtual network instance (VNI) is a specific instance of a virtual network on a NVE (e.g., a NE/VNE on an ND, a part of a NE/VNE on a ND where that NE/VNE is divided into multiple VNEs through emulation); one or more VNIs can be instantiated on an NVE (e.g., as different VNEs on an ND). A virtual access point (VAP) is a logical connection point on the NVE for connecting external systems to a virtual network; a VAP can be physical or virtual ports identified through logical interface identifiers (e.g., a VLAN ID).

Examples of network services include: 1) an Ethernet LAN emulation service (an Ethernet-based multipoint service similar to an Internet Engineering Task Force (IETF) Multiprotocol Label Switching (MPLS) or Ethernet VPN (EVPN) service) in which external systems are interconnected across the network by a LAN environment over the underlay network (e.g., an NVE provides separate L2 VNIs (virtual switching instances) for different such virtual networks, and L3 (e.g., IP/MPLS) tunneling encapsulation across the underlay network); and 2) a virtualized IP forwarding service (similar to IETF IP VPN (e.g., Border Gateway Protocol (BGP)/MPLS IPVPN) from a service definition perspective) in which external systems are interconnected across the network by an L3 environment over the underlay network (e.g., an NVE provides separate L3 VNIs (forwarding and routing instances) for different such virtual networks, and L3 (e.g., IP/MPLS) tunneling encapsulation across the underlay network)). Network services may also include quality of service capabilities (e.g., traffic classification marking, traffic conditioning and scheduling), security capabilities (e.g., filters to protect customer premises from network-originated attacks, to avoid malformed route announcements), and management capabilities (e.g., full detection and processing).

A network interface (NI) may be physical or virtual; and in the context of IP, an interface address is an IP address assigned to a NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). A loopback interface (and its loopback address) is a specific type of virtual NI (and IP address) of a NE/VNE (physical or virtual) often used for management purposes; where such an IP address is referred to as the nodal loopback address. The IP address(es) assigned to the NI(s) of a ND are referred to as IP addresses of that ND; at a more granular level, the IP address(es) assigned to NI(s) assigned to a NE/VNE implemented on a ND can be referred to as IP addresses of that NE/VNE.

A Layer 3 (L3) Link Aggregation (LAG) link is a link directly connecting two NDs with multiple IP-addressed link paths (each link path is assigned a different IP address), and a load distribution decision across these different link paths is performed at the ND forwarding plane; in which case, a load distribution decision is made between the link paths.

Some portions of the preceding detailed descriptions have been presented in terms of algorithms and symbolic representations of transactions on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments of the present invention are not described with reference to any particular programming language. It will be appreciated that a variety of programming languages may be used to implement the teachings of embodiments of the invention as described herein.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

Throughout the description, embodiments of the present invention have been presented through flow diagrams. It will be appreciated that the order of transactions and transactions described in these flow diagrams are only intended for illustrative purposes and not intended as a limitation of the present invention. One having ordinary skill in the art would recognize that variations can be made to the flow diagrams without departing from the broader spirit and scope of the invention as set forth in the following claims.

What is claimed is:

1. A method in a first network device of a virtual router redundancy protocol (VRRP) router, the VRRP router comprising of the first network device configured to serve as a backup router of the VRRP router, and a second network device configured to serve as a master router of the VRRP router, the method comprising:
in response to determining that there is a possibility that the second network device is no longer capable of forwarding network traffic as the master router of the VRRP router, transitioning into a curfew state; and
in response to determining that a VRRP advertisement message was not received within a master_down_interval, determining to not transition to serving as the master router of the VRRP router in response to determining the first network device is in the curfew state.

2. The method of claim 1, wherein determining that there is the possibility that the second network device is no longer capable of forwarding network traffic as the master router of the VRRP router comprises:
determining that a VRRP advertisement was not received within a master_down_alert_interval, wherein the master_down_alert_interval is a shorter time interval than the master_down_interval.

3. The method of claim 1, further comprising:
receiving, from the second network device, its VRRP state information; and
storing, in a database, the VRRP state information received from the second network device.

4. The method of claim 3, further comprising:
prior to transitioning into the curfew state, determining the second network device is the master router of the VRRP router based on the VRRP state information stored in the database.

5. The method of claim 1, further comprising:
in response to receiving, while in the curfew state, a VRRP advertisement from the second network device, exiting the curfew state.

6. The method of claim 1, further comprising:
in response to receiving, while in the curfew state, VRRP state information from the second network device indicating the second network device is no longer serving as the master router of the VRRP router, exiting the curfew state.

7. The method of claim 6, further comprising:
transitioning to serving as the master router of the VRRP router; and
sending VRRP state information of the first network device to the second network device.

8. The method of claim 1, further comprising:
determining to not transition to serving as the master router of the VRRP in response to determining the first network device is in the curfew state, without participating in a VRRP master election process.

9. A first network device of a virtual router redundancy protocol (VRRP) router, the VRRP router comprising of the first network device configured to serve as a backup router of the VRRP router, and a second network device configured to serve as a master router of the VRRP router, the first network device comprising:
a set of one or more processors; and
a non-transitory machine-readable storage medium containing code, which when executed by the set of one or more processors, cause the first network device to:
in response to determining that there is a possibility that the second network device is no longer capable of forwarding network traffic as the master router of the VRRP router, transition into a curfew state; and
in response to determining that a VRRP advertisement message was not received within a master_down_interval, determine to not transition to serving as the master router of the VRRP router in response to determining the first network device is in the curfew state.

10. The first network device of claim 9, wherein determining that there is the possibility that the second network device is no longer capable of forwarding network traffic as the master router of the VRRP router comprises the first network device to:
determine that a VRRP advertisement was not received within a master_down_alert_interval, wherein the master_down_alert_interval is a shorter time interval than the master_down_interval.

11. The first network device of claim 9, wherein the non-transitory machine-readable storage medium further contains code, which when executed by the set of one or more processors, cause the first network device to:
receive, from the second network device, its VRRP state information; and
store, in a database, the VRRP state information received from the second network device.

12. The first network device of claim 11, wherein the non-transitory machine-readable storage medium further contains code, which when executed by the set of one or more processors, cause the first network device to:
prior to transitioning into the curfew state, determine the second network device is the master router of the VRRP router based on the VRRP state information stored in the database.

13. The first network device of claim 9, wherein the non-transitory machine-readable storage medium further contains code, which when executed by the set of one or more processors, cause the first network device to:
in response to receiving, while in the curfew state, a VRRP advertisement from the second network device, exit the curfew state.

14. The first network device of claim 9, wherein the non-transitory machine-readable storage medium further contains code, which when executed by the set of one or more processors, cause the first network device to:
in response to receiving, while in the curfew state, VRRP state information from the second network device indicating the second network device is no longer serving as the master router of the VRRP router, exit the curfew state.

15. The first network device of claim 14, wherein the non-transitory machine-readable storage medium further contains code, which when executed by the set of one or more processors, cause the first network device to:
transition to serving as the master router of the VRRP router; and
send VRRP state information of the first network device to the second network device.

16. The first network device of claim 9, wherein the non-transitory machine-readable storage medium further contains code, which when executed by the set of one or more processors, cause the first network device to:
determine to not transition to serving as the master router of the VRRP in response to determining the first network device is in the curfew state, without participating in a VRRP master election process.

17. A non-transitory computer-readable storage medium having computer code stored therein, which when executed by a processor of a first network device of a virtual router redundancy protocol (VRRP) router, the VRRP router comprising of the first network device configured to serve as a backup router of the VRRP router, and a second network device configured to serve as a master router of the VRRP router, cause the first network device to perform operations comprising:
in response to determining that there is a possibility that the second network device is no longer capable of forwarding network traffic as the master router of the VRRP router, transitioning into a curfew state; and
in response to determining that a VRRP advertisement message was not received within a master_down_interval, determining to not transition to serving as the master router of the VRRP router in response to determining the first network device is in the curfew state.

18. The non-transitory computer-readable storage medium of claim 17, wherein determining that there is the possibility that the second network device is no longer capable of forwarding network traffic as the master router of the VRRP router comprises:
determining that a VRRP advertisement was not received within a master_down_alert_interval, wherein the master_down_alert_interval is a shorter time interval than the master_down_interval.

19. The non-transitory computer-readable storage medium of claim 17, further comprising:
receiving, from the second network device, its VRRP state information; and
storing, in a database, the VRRP state information received from the second network device.

20. The non-transitory computer-readable storage medium of claim 19, further comprising:
prior to transitioning into the curfew state, determining the second network device is the master router of the VRRP router based on the VRRP state information stored in the database.

21. The non-transitory computer-readable storage medium of claim 17, further comprising:
in response to receiving, while in the curfew state, a VRRP advertisement from the second network device, exiting the curfew state.

22. The non-transitory computer-readable storage medium of claim 17, further comprising:
in response to receiving, while in the curfew state, VRRP state information from the second network device indicating the second network device is no longer serving as the master router of the VRRP router, exiting the curfew state.

23. The non-transitory computer-readable storage medium of claim 22, further comprising:
transitioning to serving as the master router of the VRRP router; and
sending VRRP state information of the first network device to the second network device.

24. The non-transitory computer-readable storage medium of claim 17, further comprising:
determining to not transition to serving as the master router of the VRRP in response to determining the first network device is in the curfew state, without participating in a VRRP master election process.
